(19) United States
(12) Patent Application Publication
(10) Pub. No.: US 2005/0021828 A1
(43) Pub. Date: Jan. 27, 2005

(54) Adaptive data delivery manager for heterogeneous data delivery pipelines

(76) Inventor: Yakov Kamen, Cupertino, CA (US)

Correspondence Address: Yakov Kamen, 19334 Greenwood Drive, Cupertino, CA, 95014, US

(21) Appl. No.: 10/877,674

(22) Filed: Jun. 26, 2004

Related U.S. Application Data
(60) Provisional application No. 60/484,514, filed on Jul. 3, 2003.

(51) Int. Cl. G06F 15/16

(52) U.S. Cl. 709/232

(57) ABSTRACT

An adaptive data delivery manager in accordance with the invention provides data delivery pipeline recognition and data source conflict resolution solutions. Both solutions can be updated periodically or occasionally. In one embodiment the data source conflict resolution component includes a semantic data analyzer to integrate multiple data sources and enhance the delivered results.

### CROSS-REFERENCE TO RELATED APPLICATIONS

This application claims the benefit of provisional patent No. 60/484,514 filed 2003 Jul. 03 by the present inventor

### FEDERALLY SPONSORED RESEARCH

Not applicable

### SEQUENCE LISTING OF PROGRAM

Not applicable

### BACKGROUND OF THE INVENTION

The present invention pertains to technology of data delivery in a heterogeneous network environment, particularly to the data delivery of the information associated with broadband content.

Usually content delivered over broadband networks is concatenated with additional associated information (called metadata or data) that describes the content's history, actors, playing time, rating, etc. This information is later used for content identification, sorting, storing, and searching. Content related information is created independently of content. This information is aggregated in special data files to be distributed to consumers together with content. Although methods and solutions of content information (or data) delivery are well established and known in the industry, choosing the best method for a concrete system is a very complex process. For instance, data can be delivered:
inside a single digital channel as a private component of the MPEG stream;
inside a single analog or digital channel using vertical blanking interval (VBI);
in a separate data delivery channel;
spread inside multiple analog or/and digital channels;
over the telephone line (POTS);
over the Internet;
over GSM/CDMA
   Each method has its own advantages and disadvantages and none of the methods have been chosen as the ultimate standard.

Most existing data delivery systems operate as follows. First, data is transmitted to the content displaying device (“CDD”) located on the user's premises using a single pre-defined method. A CDD may be a generic PC, digital (personal) video recorder (DVR/PVR), set-top box (STB), or other broadband content operation device. The CDD contains memory (and is in essence a dedicated computing device) so that the data can be stored for later transformation, parsing, and viewing. The data delivered to the CDD is recognized and downloaded first, and then is filtered and stored on the CDD. This data is frequently updated (periodically or non-periodically). A microprocessor within the CDD recognizes the data, parses, filters and stores it. Depending on the nature of the received data and capabilities of the CDD, transferred data can be displayed or used in the CDD's decision making processes.

The main disadvantage of existing systems is that they are designed to operate by using a single pre-determined data delivery mechanism. Such a design works well in some cases, but it does not work in cases where:
data is distributed and can be delivered only over several pipelines
data pipeline is available at one location and not available at another
   Examples 1 and 2 below illustrate the above problems.

### EXAMPLE 1

In a broadband system a predefined channel delivers the next two hours of schedule data inside MPEG private data area. At the same time two-week schedule information is delivered over another dedicated channel. The two-week schedule is updated every 24 hours and two-hour schedule is updated every 30 minutes. The data delivery solution implemented in this broadband system can not work with more then one data pipeline. Therefore it ignores the two-hour schedule information delivered on the predefined channel and exclusively uses the two week schedule. The disadvantage of such a solution is the inability to make schedule corrections more often then every 24 hours.

### EXAMPLE 2

A standalone personal digital video recorder (PVR) can acquire data over the Internet using its Ethernet port, over VBI, or over a POTS line using an embedded modem. The manufacturer used a single pipeline system and chose VBI as the only data delivery mechanism. In an area where VBI data delivery is not available this PVR device can not provide schedule information and therefore can not operate properly.

The proposed invention solves the problems described above by creating systems with intelligent routing functionality controlled by an adaptive data delivery manager.

### SUMMARY

A Data Delivery Manager in accordance with one embodiment of the invention is a system that includes a mechanism of data delivery pipeline routing, that has the ability to determine the optimal data delivery pipeline based on pre-defined criteria of data delivery effectiveness.

In one embodiment of the invention, the system allows a periodical switch from one data delivery pipeline to another.

In another embodiment of the invention, the system allows a non-periodical switch from one data delivery pipeline to another.

In another embodiment of the invention, the system adapts the pipeline routing process in accordance to external rules.

### BRIEF DESCRIPTION OF THE DRAWINGS

FIG. 1 shows a Block Diagram of a Data Delivery System in Accordance with the present invention.

### DETAILED DESCRIPTION

This invention relates to a data delivery system that delivers information associated with broadcast content, to the user. The broadcast content is viewed by the user on a television, a PCTV, or a mobile video displaying device. A PCTV is a personal computer having the capability of displaying video programs. This invention also relates to an improved data delivery system that uses a special pipeline switching mechanism to route data in the most cost-effective and accurate way, increasing the efficiency of navigation through data visualization systems (like EPG) and quality of provided content- related information.

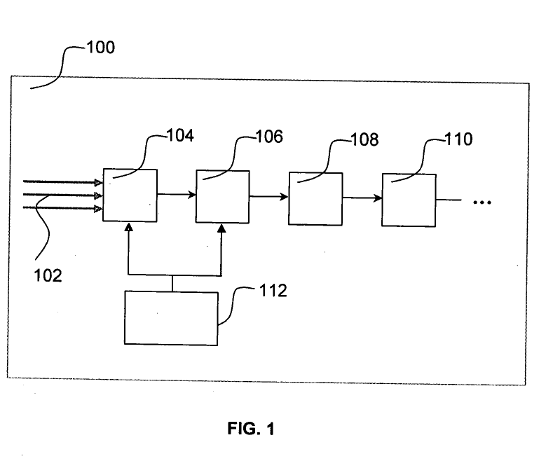

FIG. 1 describes a preferred embodiment of the invention. According to this embodiment one or more data pipelines 102 are connected to a pipeline recognition block 104. The block 104 recognizes connected data pipelines based on existing pipeline recognition rules. Pipeline recognition rules can be edited by adding new rules, deleting existing rules, or modifying existing rules. The pipeline recognition rule control is provided by the manager update block 112. When pipelines are recognized in block 104 the control is transferred to the conflict resolution block 106. Conflict resolution block 106 decides how to modify delivered data when information is different or conflicting. For example, the first pipeline delivered information that channel 5 will show news at 9:00 am. At the same time the second pipeline delivered information that channel 5 will show a movie at 9:00 am. The conflict resolution block resolves this problem. In the preferred embodiment, the conflict resolution block assigns special ratings to all pipelines. According to that rating, the pipeline with the higher rating value will be used as the lead source of data in a conflict situation. In the case where the two ratings are the same, the source of data is chosen arbitrary. Block 106 can be updated by adding new conflict resolution rules, deleting old rules, or editing existing rules. All updates are controlled by manager update block 112. The conflict resolution block 106 transfers control to the data acquisition block 108. The data acquisition block 108 acquires non-conflicting data and transfers it to the data filtering and storing block 110. The block 110 filters the data and stores it in the local file system or special database.

The algorithm that outlines the preferred embodiment's operation follows:

The manager update block 112 periodically updates the pipeline recognition block 104 and conflict resolution block 106.

The pipeline recognition block 104 analyzes the data pipelines 102. This analysis is provided at the original system installation, every time a block is updated, a new pipeline is added, or old pipeline is eliminated. When data delivery pipelines can not been recognized by block 104, the data delivery manager generates a signal that no data is available.

If only one pipeline is recognized by block 112 then the conflict resolution block 106 simply propagates control to the data acquisition block 108.

If more than one pipeline has been recognized then the pipeline recognition block 104 transfers control to the conflict resolution block 106.

The conflict resolution block 106 searches for any possible data conflicts. If no conflicts have been found the data is transferred to the data acquisition block 108. All conflicts will be resolved by block 106. The new fixed data is transferred to the data acquisition block 108 and then to the filtering and storing block 110 for additional filtering (for example, event name truncation) and storing in a database or file.

### ADDITIONAL EMBODIMENTS

In one embodiment, the conflict resolution block 6 assigns a rating to each channel separately. In that case data for one channel can be taken from one pipeline and data for another channel from another one.

In one embodiment, the conflict resolution block 6 assigns a rating to each event separately.

In one embodiment, the conflict resolution block 6 includes a special semantic analyzer that merges data from different pipelines together. For example two different pipelines provide information about the same movie. The first pipeline has movie star rating data but does not have its cast information. The second pipeline does not provide star rating data but includes movie cast information. The data semantic analyzer described above will merge the data together.

Accordingly, the reader can see that the adaptive data delivery manager in this invention can be used to deliver data easily, conveniently, and economically. It allows the data delivery system to be updated to support new emerging standards, and to receive the most accurate data in the most cost-effective way. Furthermore, the adaptive data delivery manager has the additional advantages:
it permits hardware manufacturers to develop next generation products that may support several data delivery methods;
it allows building mobile solutions independent from data delivery pipelines.
   Although the description above contains much specificity, these should not be construed as limiting the scope of the invention but as merely providing illustrations of some presently preferred embodiment of this invention.

1. A method of adaptive data delivery management for heterogeneous data delivery pipelines comprising:
recognition of connected heterogeneous data pipelines; and
a criterion for said pipeline recognition; and
resolution of multiple data source conflicts; and
a criterion for conflict resolution; and
filtering and storing of conflict free data in a content displaying device.

2. The method of claim 1 wherein said pipeline recognition is controlled by an adaptive pipeline recognition control mean.

3. The method of claim 1 wherein said resolution of said data source conflicts is controlled by an adaptive conflict resolution control mean.

4. The method of claim 1 wherein said conflict resolution criteria chooses a single data pipeline as a unique data source.

5. The method of claim 4 wherein said chosen data pipeline is changed periodically by switching from one data pipeline to another data pipeline.

6. The method of claim 4 wherein said chosen data pipeline is changed occasionally by switching from one data pipeline to another data pipeline.

7. The method of claim 1 wherein said conflict resolution mean includes a semantic mean that merges said data sources together by analyzing the internal structure of data in each data source.

8. An apparatus comprising:
data delivery pipelines; and
said pipeline recognition mean; and
said data conflict resolution mean.

9. The apparatus of claim 8 wherein said pipeline recognition mean is connected with a pipeline recognition update mean to change said pipeline recognition mean periodically.

10. The apparatus of claim 8 wherein said pipeline recognition mean is connected with a pipeline recognition update mean to change said pipeline recognition mean occasionally.

11. The apparatus of claim 8 wherein said data conflict resolution mean is connected with said data conflict resolution update mean to change said data conflict resolution mean periodically.

12. The apparatus of claim 8 wherein said data conflict resolution mean is connected with said data conflict resolution update mean to change said data conflict resolution mean occasionally.

13. The apparatus of claim 8 wherein said data conflict resolution mean is a switch between said data delivery pipelines.

14. The apparatus of claim 13 wherein said switch can be programmed to provide complex data delivery control.

15. The apparatus of claim 13 wherein said switch depends on the associated content's characteristics.

16. The apparatus of claim 8 wherein said data conflict resolution mean comprises a semantic data analyzer to integrate said data sources.
